(19) United States
(12) Patent Application Publication
(10) Pub. No.: US 2009/0068431 A1
(43) Pub. Date: Mar. 12, 2009

(54) One-Sided Tacky Polyolefin Film

(75) Inventor: Martin F. Hoenigmann, Chippewa Falls, WI (US)

Correspondence Address: MCANDREWS HELD & MALLOY, LTD, 500 WEST MADISON STREET, SUITE 3400, CHICAGO, IL, 60661, US

(73) Assignee: PLIANT CORPORATION, Schaumburg, IL (US)

(21) Appl. No.: 11/658,075

(22) PCT Filed: Jul. 30, 2004
(86) PCT No.: PCT/US2004/024915

§ 371 Date: Nov. 21, 2008

(51) Int. Cl. B32B 27/32

(52) U.S. Cl. 428/220; 428/515; 428/343; 428/346; 428/513; 428/409

(57) ABSTRACT

A multi-layer film having a tacky or non-skid surface includes at least one non-tacky first layer composed of at least one polyolefin polymer. At least one second tacky layer is also provided and is composed of metallocene-catalyzed polyolefin polymers, ethylene copolymer resins, styrene-ethylene/butylene-styrene block copolymers and mixtures thereof.

### TECHNICAL FIELD

The present invention relates to films having a tacky or non-skid surface. In particular, the present invention is directed to a polyolefin film having a base film or first non-tacky surface composed of a polyolefin polymer and a second tacky surface composed of metallocene-catalyzed polyolefin polymers, ethylene copolymers and/or styrene-ethylene/butylene-styrene block copolymers.

### BACKGROUND ART

As manufacturers of medical devices, personal products, and even industrial devices continue efforts to conserve resources and reduce waste, they are seeking new materials that can meet application needs while providing opportunities for volume or weight reductions. In particular, such manufacturers are seeking one-sided tacky or non-skid films for a variety of uses including, but not limited to, non-skid drop cloths, non-skid diaper changing pads and many other uses where a tacky surface is desirable. Fabricators are also looking for ways to reduce the thickness, weight, or volume of packaging or other films without sacrificing the structural integrity or functionality of the film.

### DISCLOSURE OF THE INVENTION

The multi-layer film of the present invention includes a first layer composed of at least one polyolefin polymer. A second layer is also provided and is composed of metallocene-catalyzed polyolefin polymers, ethylene copolymer resins, and mixtures thereof.

### BEST MODE FOR CARRYING OUT OF THE INVENTION

The multi-layer film of the present invention has a structure that includes at least one first layer composed of at least one polyolefin polymer. At least one second layer also includes at least one compound selected from metallocene-catalyzed polyolefin polymers, ethylene copolymer resins, styrene-ethylene/butylene-styrene block copolymers and mixtures thereof.

The total thickness of the film may vary and depends on the intended application for the film. The preferred film has a total thickness up to about 15 mils and, more preferably, from about 0.5-15 mils. The thickness of each separate inner layer is preferably from about 0.1-7.0 mils, more preferably from about 0.2-3.0 mils, and most preferably from about 2.0-3.0 mils. The preferred thickness of the first layer constitutes from about 40-98% by weight of the whole film structure, more preferably from about 70-95%, and most preferably about 80%. Conversely, the preferred thickness of the second layer is from about 2-40% by weight of the whole film structure, and most preferably about 20%. It will be appreciated by those skilled in the art that the thickness of each individual layer may be similar or different in addition to having similar or different compositions. The thickness of each layer is therefore independent and may vary within the parameters set by the total thickness of the film. The preferred multi-layer also has a coefficient of friction (CoF) to metal, film and/or plexiglass of 0.5 or greater as measured by ASTM D 1894.

The multi-layer film of the present invention may be produced by conventional methods used in producing multi-layer films including coextrusion and extrusion lamination techniques. In the most preferred method, the film is formed by coextrusion. Melted and plasticated streams of the individual layer materials are fed into a coextrusion die. While in the die, the layers are juxtaposed and combined then emerge from the die a single multiple layer film of polymeric material. Suitable coextrusion techniques are more fully described in U.S. Pat. Nos. 5,139,878 and 4,677,017, incorporated herein by reference to the extent permitted by law, except that coextrusion of the present invention may be conducted at temperatures at from about 400° F. to about 510° F. Coextrusion techniques include the use of a feed block with a standard die, a multi-manifold die such as a circular die, as well as a multi-manifold die such as used in forming flat cast films and cast sheets. The multi-layer films of the present invention may also be preferably made by blown film coextrusion. The film is formed using a blown film apparatus composed of a multi-manifold circular die head having concentric circular orifices. The multi-layer film is formed by coextruding a molten layer through a circular die, and a molten layer on the other or each opposite side of the first layer through additional circular dies concentric with the first circular die. Then a gas, typically air, is blown through a jet that is concentric with the circular dies thereby forming a bubble expanding the individual layers. The bubble is then collapsed upon itself into a pair of attached multi-layer films attached at two opposite edges. Usually, the pair of attached multi-layer films are then cut apart at one or more of the edges and separated into a pair of multi-layer films that may then be rolled up.

In the preferred film, the preferred at least one first layer is composed of from about 20-100% by weight, more preferably about 95%, of at least one polyolefin polymer. Preferred polyolefin polymers include polyethylene, polypropylene, polybutenes, polyisoprene, copolymers thereof, terpolymers thereof, α-olefin propylene copolymers, and mixtures thereof. Suitable polyethylenes include, in particular, low density polyethylene (LDPE), linear low density polyethylene (LLDPE), and ultra low density polyethylene (ULDPE). Preferred propylene polymers generally contain from about 90-100% by weight of propylene units and the preferred propylene polymers generally have a melting point of 130° C. or above. Preferred propylene polymers generally have a melt flow index of from 0.5 g/10 min to 10 g/10 min at 230° C. and a force of 21.6 N. Isotactic propylene homopolymer having an n-heptane-soluble content of from about 1-15% by weight, copolymers of ethylene and propylene having an ethylene content of 10% by weight or less, copolymers of propylene with C₄-C₈ α-olefins having an α-olefin content of 10% by weight or less, and terpolymers of propylene, ethylene and butylene having an ethylene content of 10% by weight or less and a butylene content of 15% by weight or less are preferred propylene polymers. Also suitable is a mixture of propylene homopolymers, copolymers, terpolymers and other polyolefins.

It will be appreciated by those skilled in the art that additives may be added to the first layer or to one or more other layers of the film of the present invention in order to improve certain characteristics of the particular layer. From about 0-80% by weight of the preferred first layer or other individual layer, more preferably about 5%, of one or more additives may be added. Preferred additives include color concentrates, neutralizers, process aids, lubricants, stabilizers, hydrocarbon resins, antistatics, and antiblocking agents. A color concentrate may be added to the layer to yield a colored layer, an opaque layer, or a translucent layer. Preferred color concentrates include color formulations including black, white, and other colors suitable for blown films such as those manufactured by Ampacet Corporation (Tarrytown, N.Y.). Preferred color concentrates include Ampacet® white PE masterbatch, the carrier resin of which being a LLDPE having a melt index of 20 g/10 min and a density of 0.92 gm/cc and the concentrate of which has a nominal specific gravity of 2.06, a melt index of 3-23 g/10 min and nominally contains 75% ash. Another preferred color concentrate includes Ampacet® white HDPE masterbatch, the carrier resin of which being a HD/LLDPE having a nominal melt index of 10 g/10 min and a density of 0.96 gm/cc. The concentrate has a nominal specific gravity of 1.54, a melt index of 9-15 g/10 min, and a pigment composed of 50% TiO₂.

Suitable neutralizers include calcium carbonate and calcium stearate. Preferred neutralizers have an absolute particle size of less than 10 μm and a specific surface area of at least 40 m²/g. Polymeric processing aids may also be used in a layer. Fluoropolymers, fluoropolymer blends, and fluoroelastomers are particularly preferred, but any processing aid known in the art for use in polymer films would be suitable. A particularly preferred processing aid is Ampacet® Process Aid PE masterbatch having a LLDPE carrier resin with a nominal melt index of 2 g/10 min and a density of 0.918 gm/cc. The concentrate therein has a nominal specific gravity of 0.91, a nominal melt index of 1-3 g/10 min, and contains 3% ash.

Lubricants that may used in accordance with the present invention include higher aliphatic acid esters, higher aliphatic acid amides, metal soaps, polydimethylsiloxanes, and waxes. Conventional stabilizing compounds for polymers of ethylene, propylene, and other α-olefins are preferably employed in the present invention. In particular, alkali metal carbonates, alkaline earth metal carbonates, phenolic stabilizers, alkali metal stearates, and alkaline earth metal stearates are preferentially used as stabilizers for the composition of the present invention.

Hydrocarbon resins and, in particular, styrene resins, terpene resins, petroleum resins, and cyclopentadiene resins have been found to be suitable as additives in order to improve desirable physical properties of the film. These properties may include water vapor permeability, shrinkage, film rigidity and optical properties. In particular, adhesive resins are preferred. A particularly preferred adhesive resin is sold under the trademark Bynel® by DuPont Corporation and is primarily composed of maleic anhydride modified polyolefin with some residual maleic anhydride and may also contain small amounts of stabilizers, additives and pigments.

Preferred antistatics include substantially straight-chain and saturated aliphatic, tertiary amines containing an aliphatic radical having 10-20 carbon atoms that are substituted by ω-hydroxy-(C₁-C₄)-alkyl groups, and N,N-bis-(2-hydroxyethyl)alkylamines having 10-20 carbon atoms in the alkyl radical. Other suitable antistatics include ethyoxylated or propoxylated polydiorganosiloxanes such as polydialkysiloxanes and polyalkylphenylsiloxanes, and alkali metal alkanesulfonates.

Preferred antiblocking agents include organic polymers such as polyamides, polycarbonates, polyesters. Other preferred agents include calcium carbonate, aluminum silicate, magnesium silicate, calcium phosphate, silicon dioxide, and diatomaceous earth.

The preferred at least one second layer is preferably composed of from about 90-100% by weight of the layer, more preferably about 95%, of a metallocene-catalyzed polyolefin polymer, ethylene copolymer resin, styrene-ethylene/butylene-styrene block copolymers, or mixtures thereof. Preferred metallocenes are single site catalysts and include dicyclopentadienyl-metals and -metal halides. A preferred polyolefin polymer is an ethylene-based polymer such as a hexene copolymer produced with metallocene single site catalysts. Most preferred is metallocene linear low density polyethylene (mLLDPE) and metallocene low density polyethylene (mLDPE). The preferred mLLDPE and mLPDE have a density of about 0.9 g/cm³ or less. Preferred ethylene copolymer resins include ethylene vinyl acetate copolymer resins (EVA), ethylene methyl acrylate copolymer resins (EMA), and mixtures thereof. In the preferred embodiment, the second layer may also include from about 0-10% by weight of the layer, more preferably about 5%, of a tackifier. Preferred tackifiers include rubber-based tackifiers, acrylic tackifiers, vinyl ether-based tackifiers, silicone-based tackifiers, heat sensitive tackifiers having a delayed tackifying property, and the like. Mixtures of such tackifiers are also suitable for use in the second layer of the film of the present invention.

In the preferred embodiments of the film of the present invention described hereinabove, the film structure is a two-layer structure. It will be appreciated by those skilled in the art that additional layers could be added to the film to form a film having up to ten layers. In addition to one or more of the first and second layers described above, at least one additional layer composed of polymer non-woven textiles including polyester, polypropylene, and polyethylene, or tissue paper may be provided wherein the first layer is laminated to the non-woven textile or tissue paper. Generally, in order to so laminate, at least one adhesive tie layer may also be provided between the textile or paper layer and the first layer in order to provide sufficient adhesion of the polyolefin polymer layer to the textile or paper layer.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

### Example 1

A two-layer film having a total film thickness of 1.0 mils was produced using the formula set forth in Table 1.

TABLE 1
Formulation 1-2 Layer Film Formulation

| Layer | Ratio | Cell | % bw | Type | ID | Mfr |
|---|---|---|---|---|---|---|
| A | 75% | A-1 | 65.0 | Hexene LLDPE | TF-0338E | Nova |
| | | A-2 | 30.0 | LDPE | LGA105 | Exxon |
| | | A-3 | 5.0 | White PE MB | 111017 | Ampacet |
| B | 25% | B-1 | 100.0 | EVA Resin | 3175LGZ | DuPont |

### Example 2

A second two-layer film having a total film thickness of 0.75 mils was also produced using the formula set forth in Table 1.

### Example 3

A two-layer film having a total film thickness of 1.0 mils was produced using the formula set forth in Table 2.

TABLE 2
Formulation 2-2 Layer Film Formulation

| Layer | Ratio | Cell | % bw | Type | ID | Mfr |
|---|---|---|---|---|---|---|
| A | 75% | A-1 | 65.0 | Hexene LLDPE | TF-0338E | Nova |
| | | A-2 | 30.0 | LDPE | LGA105 | Exxon |
| | | A-3 | 5.0 | White PE MB | 111017 | Ampacet |
| B | 25% | B-1 | 100.0 | mPOP* | KC8852 | Dow |

*mPOP = metallocene-catalyzed polyolefin plastomer

### Example 4

A two-layer film having a total film thickness of 0.75 mils was produced using the formula set forth in Table 2.

### Example 5

A two-layer film having a total film thickness of 1.0 mils was produced using the formula set forth in Table 3.

TABLE 3
Formulation 3-2 Layer Film Formulation

| Layer | Ratio | Cell | % bw | Type | ID | Mfr |
|---|---|---|---|---|---|---|
| A | 75% | A-1 | 65.0 | Hexene LLDPE | TF-0338E | Nova |
| | | A-2 | 30.0 | LDPE | LGA105 | Exxon |
| | | A-3 | 5.0 | Blue PE MB | 161122 | Ampacet |
| B | 25% | B-1 | 100.0 | mPOP | KC8852 | Dow |

### Example 6

A two-layer film having a total film thickness of 0.75 mils was produced using the formula set forth in Table 3.

### Example 7

The film produced using Formulations 3 described above in Example 5 was tested for various characteristics. The results of such tests are shown in Table 4

TABLE 4
Film Test Results

| | | (disc weight) |
|---|---|---|
| Gauge | g/m² | 24.83 |
| (Ave.) | mil | 1.01 |
| Tensile Yield | MD | 3228 |
| (g/in²) | CD | 2464 |
| Ultimate Tensile | MD | 2502 |
| (g/in²) | CD | 1839 |
| Ultimate Elongation | MD | 682 |
| (%) | CD | 746 |
| 10% Tensile Load | MD | 253 |
| (g/in²) | CD | 236 |
| 25% Tensile Load | MD | 434 |
| (g/in²) | CD | 370 |
| C.O.F. | Metal | 1.950-2.195 |
| tacky side to: | Plexiglass | 1.410-2.220 |
| Light Transmission | Range | 64.8-68.4 |
| (%) | Avg | 66.6 (1.09) |

### Example 8

A two-layer film having a total thickness of 1.0 mils was produced using the formula set forth in Table 5.

TABLE 5
Formulation 4-2 Layer Film Formulation

| Layer | Ratio | Cell | % bw | Type | ID | Mfr |
|---|---|---|---|---|---|---|
| A | 85% | A-1 | 75.0 | propylene | 5724 | Fina |
| | | | | copolymer | | |
| | | A-2 | 20.0 | LDPE | LGA 105 | Exxon |
| | | A-3 | 5.0 | White PE MB | 111017 | Ampacet |
| B | 15% | B-1 | 100.0 | mPOP | KC8852 | Dow |

### Example 9

A two-layer film having a total thickness of 0.75 mils was produced using the formula set forth in Table 5.

### Example 10

The physical properties of Formulation 4 as produced in Examples 8 and 9 above were determined. The results are shown below in Table 6.

TABLE 6
Physical Properties Test Results.

| | ASTM | | Formulation 4 | Formulation 4 |
|---|---|---|---|---|
| Property | Test # | Units | Example 8 | Example 9 |
| Gauge | D 2103 | Mils | 1.06 | 2.08 |
| Light Transmission | D 1003 | % | 63.4 | 53.6 |
| Slow Puncture | D 3763 | Grams | 1865 | 2579 |
| M.D. Strip/Gauge | D 2103 | Mils | 1.05 | 2.08 |
| M.D. | D 882 | grams | 2355 | 3857 |
| Tensile @ Break | | | | |
| M.D. Elongation | D 882 | % | 594 | 562 |
| M.D. Yield | D 882 | grams | 738 | 1451 |
| M.D. Elongation @ | D 882 | % | 12 | 11 |
| Yield | | | | |
| M.D. Tensile @ 5% | D 882 | grams | 616 | 1236 |
| M.D. | D 882 | grams | 727 | 1437 |
| Tensile @ 10% | | | | |
| M.D. | D 882 | grams | 727 | 1428 |
| Tensile @ 25% | | | | |
| M.D. Secant | D 882 | Psi | 41779 | 53988 |
| Modulus | | | | |
| M.D. | D 1922 | grams | 247 | 362 |
| Elmendorf Tear | | | | |
| M.D. Trouser Tear | D 1938 | grams | 58 | 116 |
| T.D. Strip/Gauge | D 2103 | Mils | 1.05 | 2.08 |
| T.D. | D 882 | grams | 1372 | 2214 |
| Tensile @ Break | | | | |
| T.D. Elongation | D 882 | % | 571 | 500 |
| T.D. Yield | D 882 | grams | 615 | 1293 |
| T.D. | D 882 | % | 12 | 11 |
| Elongation @ Yield | | | | |
| T.D. Elmendorf | D 1922 | Grams | | 511 |
| Tear | | | | |
| T.D. Secant | D 882 | Psi | 51944 | 52917 |
| Modulus | | | | |
| T.D. Tensile @ 5% | D 882 | grams | 499 | 1092 |
| T.D. | D 882 | grams | 605 | 1282 |
| Tensile @ 10% | | | | |
| T.D. | D 882 | grams | 598 | 1266 |
| Tensile @ 25% | | | | |
| T.D. Secant | D 882 | psi | 34712 | 36707 |
| Modulus | | | | |
| T.D. Trouser Tear | D 1938 | grams | 126 | 261 |
| T.D. Elmendorf | D 1922 | grams | 624 | 776 |
| Tear | | | | |

### Example 11

A two-layer film having a total thickness of 1.0 mils was produced using the formula set forth in Table 7.

TABLE 7
Formulation 5-2 Layer Film Formulation

| Layer | Ratio | Cell | % bw | Type | ID | Mfr |
|---|---|---|---|---|---|---|
| A | 85% | A-1 | 65.0 | HDPE | 9659 | Chevron |
| | | A-2 | 20.0 | LDPE | LGA 105 | Exxon |
| | | A-3 | 5.0 | White PE MB | 111017 | Ampacet |
| B | 15% | B-1 | 100.0 | mPOP | KC8852 | Dow |

### Example 12

A two-layer film having a total thickness of 0.75 mils was produced using the formula set forth in Table 7.

### Example 13

A two-layer film having a total thickness of 1.0 mils was produced using the formula set forth in Table 8.

TABLE 8
Formulation 5-2 Layer Film Formulation

| Layer | Ratio | Cell | % bw | Type | ID | Mfr |
|---|---|---|---|---|---|---|
| A | 5% | A-1 | 100.0 | adhesive polymer | Bynel | DuPont |
| | | | | | E418 | |
| B | 70% | B-1 | 65.0 | Hexene LLDPE | TF-0338E | Nova |
| | | B-2 | 30.0 | LDPE | LGA105 | Exxon |
| | | B-3 | 5.0 | Blue PE MB | 161122 | Ampacet |
| C | 25% | C-1 | 100.0 | mPOP | KC8852 | Dow |

### Example 14

A two-layer film having a total thickness of 0.8 mils was produced using the formula set forth in Table 8.

### Example 15

A two-layer film having a total thickness of 0.8 mils was produced using the formula set forth in Table 8.

### Example 16

The films produced in Examples 13, 14 and 15 were laminated to a 52# DRC tissue paper (72 GSM)(2.12). The COF of each film was tested and the results are shown below in Table 9.

| | | 1.0 mils | 0.8 mils | 0.6 mils |
|---|---|---|---|---|
| C.O.F. | Metal | 0.835-1.000 | 0.910-1.050 | 0.800-1.000 |
| | Plexiglass | 1.645-1.720 | 1.730-1.860 | 1.580-1.770 |

### Example 17

The films produced in Examples 13, 14 and 15 were laminated to a 40# DRC tissue paper (55 GSM)(1.62). The COF of each film was tested and the results are shown below in Table 9.

| | | 1.0 mils | 0.8 mils | 0.6 mils |
|---|---|---|---|---|
| C.O.F. | Metal | 0.985-1.120 | 0.960-1.200 | 1.155-1.260 |
| | Plexiglass | 1.690-1.860 | 1.865-2.005 | 1.915-2.095 |

The foregoing description of the embodiments of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and modifications as are suited to the particular use contemplated. It is intended that the scope of the invention not be limited by the specification, but be defined by the claims set forth below.

We claim:

1. A multi-layer film comprising:
at least one first layer comprising at least one polyolefin polymer; and
at least one second layer comprising at least one compound selected from the group consisting of metallocene-catalyzed polyolefin polymers, ethylene copolymer resins, styrene-ethylene/butylene-styrene block copolymers, and mixtures thereof.

2. The film of claim 1 wherein said first layer comprises from about 20-100% by weight of said at least one polyolefin polymer.

3. The film of claim wherein said first layer comprises from about 90-99% by weight of said at least one polyolefin polymer.

4. The film of claim 1 wherein said polyolefin polymer is selected from the group consisting of polyethylene, polypropylene, polybutenes, polyisoprene, copolymers thereof, terpolymers thereof, α-olefin propylene copolymers, and mixtures thereof.

5. The film of claim 4 wherein said polyolefin polymer is selected from the group consisting of linear low density polyethylene, low density polyethylene, ultra low density polyethylene, and mixtures thereof.

6. The film of claim 2, said first layer further comprising from about 0-80% by weight of at least one additive.

7. The film of claim 6 wherein said additive is selected from the group consisting of color concentrates, tackifiers, neutralizers, process aids, lubricants, stabilizers, hydrocarbon resins, antistatics, and antiblocking agents.

8. The film of claim 1 wherein said first layer comprises from about 40-98% by weight of said film.

9. The film of claim wherein said second layer comprises from about 10-100% of said compound.

10. The film of claim 1 wherein said metallocene-catalyzed polyolefin polymers are selected from the group consisting of metallocene linear low density polyethylene, metallocene low density polyethylene, and mixtures thereof.

11. The film of claim 1 wherein said metallocene-catalyzed polyolefin polymer has a density of about 0.9 g/cm³ or less.

12. The film of claim 1 wherein said ethylene copolymer resins are selected from the group consisting of ethylene vinyl acetate copolymer resins, ethylene methyl acrylate copolymer resins, and mixtures thereof.

13. The film of claim 12 wherein said ethylene vinyl acetate copolymer resins comprises from about 5% by weight ethylene vinyl acetate.

14. The film of claim 12 wherein said ethylene methyl acrylate copolymers resins comprise about 5% by weight ethylene methyl acrylate.

16. The film of claim 9 wherein said second layer further comprises from about 0-10% by weight of a tackifier.

17. The film of claim 16 wherein said tackifier is selected from the group consisting of rubber-based tackifiers, acrylic tackifiers, vinyl ether-based tackifiers, silicone-based tackifiers, heat sensitive tackifiers having a delayed tackifying property, and mixtures thereof.

18. The film of claim 1 wherein said second layer comprises from about 2-40% by weight of said film.

19. The film of claim 1 wherein said film has a thickness of up to 15 mils.

20. The film of claim 19 wherein said film has a thickness of from about 0.5-10) mils.

21. The film of claim 1 further comprising at least one additional layer.

22. The film of claim 21, said at least one additional layer comprising polymer non-woven textiles.

23. The film of claim 21, said at least one additional layer comprising tissue paper.

24. The film of claim 22 further comprising an adhesive tie layer disposed between said additional layer and said first layer.

25. The film of claim 23 further comprising an adhesive tie layer disposed between said additional layer and said first layer.

26. The film of claim 21 wherein said film comprises up to ten layers.

27. The film of claim 1 wherein said film has a coefficient of friction of from about 0.5 or greater.
